(19) United States
(12) Patent Application Publication
(10) Pub. No.: US 2024/0141601 A1
(43) Pub. Date: May 2, 2024

(54) METHOD AND APPARATUS FOR ROAD INSPECTION

(71) Applicant: Telefonaktiebolaget LM Ericsson (publ), Stockholm (SE)

(72) Inventor: Ning ZHANG, Beijing (CN)

(21) Appl. No.: 18/278,940

(22) PCT Filed: Mar. 5, 2021
(86) PCT No.: PCT/CN2021/079298

§ 371 Date: Aug. 25, 2023

(51) Int. Cl. E01C 23/01; G01N 21/88

(52) U.S. Cl. CPC E01C 23/01; G01N 21/8851; G01N 2021/8887

(57) ABSTRACT

Various embodiments of the present disclosure provide a method for road inspection. The method which may be performed by a user equipment includes capturing a video stream of a road. The method further includes transmitting at least part of the video stream to a server. A first video clip from the at least part of the video stream may be compared with a second video clip to determine a vibration reflecting a quality of a road section of the road.

### FIELD OF THE INVENTION

The present disclosure generally relates to communication networks, and more specifically, to a method and apparatus for road inspection.

### BACKGROUND

This section introduces aspects that may facilitate a better understanding of the disclosure. Accordingly, the statements of this section are to be read in this light and are not to be understood as admissions about what is in the prior art or what is not in the prior art.

In recent years, with the progress of computer technology, automatic control technology and high-precision micro-metering technology, road inspection develops from manual inspection to automated inspection. Currently, there are many computer-assisted devices that may greatly improve the road inspection. For instance, a device may be enhanced with a computer vision processing algorithm as well as an ultrasonic sensor to detect the damage of a road, so that the device can inspect the road more accurately.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In the existing solutions for road inspection, the road maintenance cost may be very high because professional devices and work teams may be needed for the frequent quality inspection of different roads. In addition, since the existing solutions may require the designated worker to use the professional device for road inspection, e.g., driving a car to get all expected data of the road quality, the efficiency of road inspection may be rather low and some road quality problems may be missed or detected with delay. Therefore, it may be desirable to implement road inspection in a more efficient way.

Various exemplary embodiments of the present disclosure propose a solution for road inspection, which can utilize a user equipment (UE) such as a vehicle (e.g., a car, a train, a roller coaster, etc.) or an in-vehicle device (e.g., a driving recorder, a camera, an advanced driver-assistance system, etc.) to capture a video of a road for quality inspection, so that a damage of the road can be detected, e.g., by analyzing vibrations of the captured video, with higher efficiency and improved accuracy.

It can be appreciated that the term “road” described in this document may refer to a highway, a driveway, a trafficway, a highroad or any long piece of hard ground that is built between two places so that people can drive or ride easily from one place to the other. In addition, it can be appreciated that the term “road” may also refer to a railway for trains, cable cars or roller coasters, etc., or refer to a route between two places along which transport means travel on rails or tracks made of steel or any other types of materials.

According to a first aspect of the present disclosure, there is provided a method performed by a UE. The method comprises: capturing a video stream of a road, and transmitting at least part of the video stream to a server. In accordance with an exemplary embodiment, a first video clip from the at least part of the video stream may be compared with a second video clip to determine a vibration reflecting a quality of a road section of the road.

In accordance with an exemplary embodiment, the second video clip may be a reference video clip used as a quality baseline of the road section.

In accordance with an exemplary embodiment, the second video clip may correspond to the road section with a quality equal to or higher than a predefined level.

In accordance with an exemplary embodiment, the UE may be a vehicle (e.g., a car, a train, or any other suitable transport means) or a device (e.g., a driving recorder, a camera, or any other suitable in-vehicle means) used for the vehicle. In an embodiment, the second video clip may be associated with a type of the vehicle.

In accordance with an exemplary embodiment, the vibration reflecting the quality of the road section may include one or more offsets of the first video clip relative to the second video clip.

In accordance with an exemplary embodiment, when the vibration matches a vibration pattern, the vibration may indicate one or more of:
a potential damage of the road section;
a level of the potential damage;
a road facility set on or around the road section being malfunctioned and/or moved;
a need for adjusting quality inspection of the road section; and
an abnormal status of the UE.

In accordance with an exemplary embodiment, the vibration pattern may include one or more video offsets within a predefined range, e.g., a first range which may include one or more sub-ranges corresponding to different damage levels, a second range associating with the need for adjusting quality inspection of the road section, etc.

In accordance with an exemplary embodiment, the first video clip may be determined by the UE and/or the server. In an embodiment, the first video clip may be determined according to one or more of:
the UE being distant from a road facility by a predefined value;
the UE arriving at a predetermined position; and
the UE entering and/or leaving the road section.

In accordance with an exemplary embodiment, the comparison between the first video clip and the second video clip may be based at least in part on one or more of:
a relative position of the UE to a road facility;
an absolute position of the UE; and
a trajectory of the UE.

In accordance with an exemplary embodiment, the method according to the first aspect of the present disclosure may further comprise: receiving a notification from the server. The notification may indicate a potential damage of the road section and/or an abnormal status of the UE.

In accordance with an exemplary embodiment, the abnormal status of the UE may be determined (e.g., by the server or another device which may be accessible by the server) according to the vibration reflecting the quality of the road section and/or sensor data collected by one or more road facilities for the UE.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided a method performed by a server. The method comprises: receiving at least part of a video stream captured for a road from a UE. In accordance with an exemplary embodiment, the method further comprises: determining a vibration reflecting a quality of a road section of the road, by comparing a first video clip from the at least part of the video stream with a second video clip.

In accordance with some exemplary embodiments, the at least part of the video stream received by the server according to the fourth aspect of the present disclosure may correspond to the at least part of the video stream transmitted by the UE according to the first aspect of the present disclosure. Similarly, the first video clip and the second video clip according to the fourth aspect of the present disclosure may respectively correspond to the first video clip and the second video clip according to the first aspect of the present disclosure. Thus, the first/second video clip according to the first aspect of the present disclosure and the first/second video clip according to fourth aspect of the present disclosure may have the same or similar contents and/or feature elements. Correspondingly, the determination of the vibration reflecting the quality of the road section according to the first and fourth aspects of the present disclosure may be based on the same or similar parameter(s) and/or criterion(s).

In accordance with an exemplary embodiment, when the vibration indicates a potential damage of the road section, the method according to the fourth aspect of the present disclosure may further comprise: informing the potential damage of the road section to the UE, one or more other UEs, a road construction team, and/or a road maintenance team.

In accordance with an exemplary embodiment, the method according to the fourth aspect of the present disclosure may further comprise: obtaining sensor data collected by one or more road facilities for the UE, and performing the comparison between the first video clip and the second video clip, based at least in part on the sensor data.

In accordance with an exemplary embodiment, the method according to the fourth aspect of the present disclosure may further comprise: transmitting a notification to the UE to indicate an abnormal status of the UE.

In accordance with an exemplary embodiment, the server may be implemented at the UE, a base station, a road facility, an edge computing device, and/or a cloud device.

According to a fifth aspect of the present disclosure, there is provided an apparatus which may be implemented as a server. The apparatus may comprise one or more processors and one or more memories storing computer program codes. The one or more memories and the computer program codes may be configured to, with the one or more processors, cause the apparatus at least to perform any step of the method according to the fourth aspect of the present disclosure.

According to a sixth aspect of the present disclosure, there is provided a computer-readable medium having computer program codes embodied thereon which, when executed on a computer, cause the computer to perform any step of the method according to the fourth aspect of the present disclosure.

According to a seventh aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the fourth aspect of the present disclosure.

According to an eighth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the fourth aspect of the present disclosure.

According to a ninth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first aspect of the present disclosure.

According to a tenth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first aspect of the present disclosure.

According to an eleventh aspect of the present disclosure, there is provided a method implemented in a communication system which may include a host computer, a base station and a UE. The method may comprise, at the host computer, receiving user data transmitted to the base station from the UE which may perform any step of the method according to the first aspect of the present disclosure.

According to a twelfth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first aspect of the present disclosure.

According to a thirteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the fourth aspect of the present disclosure.

According to a fourteenth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the fourth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an exemplary system architecture according to an embodiment of the present disclosure;

FIG. 2A is a diagram illustrating an exemplary system design according to an embodiment of the present disclosure;

FIG. 2B is a diagram illustrating an exemplary road inspection procedure according to an embodiment of the present disclosure;

FIG. 3 is a diagram illustrating an exemplary solution of video analysis according to an embodiment of the present disclosure;

FIG. 4 is a diagram illustrating an exemplary rail deform inspection assistant solution according to an embodiment of the present disclosure;

FIG. 5A is a flowchart illustrating a method according to an embodiment of the present disclosure;

FIG. 5B is a flowchart illustrating another method according to an embodiment of the present disclosure;

FIG. 6 is a block diagram illustrating an apparatus according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Currently, various sensors and computer processing schemes may be used to detect the damage of roads. However, the road maintenance cost may be rather high due to expense equipment, and the activity may be inefficient even though there are car-boned inspection tools. For example, the worker may need to drive the car to patrol along all road sections to get all expected road quality status data. Since the velocity of the inspection is relatively low, it may cause traffic congestion which is a potential economical lost. Moreover, the worse scenario may be that some road quality problems are discovered too late, which may make accidents already happen. This situation may also exist on railways for public trains and roller coaster in amusement parks, which may be even more dangerous.

Also, from technology perspective, if the road is just polluted rather than damaged, the existing solutions for road inspection may not identify whether it is really damaged or not. Consequently, there may be some false alerts happened, which may also consume much human efforts to distinguish them from real damages. In such cases, the cleaning work may need to be informed rather than the maintenance team.

Various exemplary embodiments of the present disclosure propose a solution for road inspection. In accordance with an exemplary embodiment, a UE such as a vehicle travelling along a road can be utilized for road quality inspection. According to the proposed solution, a video captured by a camera (e.g., a driving recorder, etc.) build-in the vehicle may be analyzed and compared with the standard video which may be captured right after the road is constructed (or maintained) with passing of the quality inspection. According to an embodiment, if the video offset delta (e.g., a vibration) of the currently captured video relative to the standard video is over a threshold of the quality level in a certain road section, then it may indicate that this road section needs to be maintained. Since there may be always vehicles travelling along all road sections, the inspection result (e.g., different video offset delta values, etc.) can be concluded by the average of these values or another certain pattern according to the experience of each maintenance activity.

It can be appreciated that although some exemplary embodiments are described with respect to a car, various embodiments described in the present disclosure can also be applied on railways for trains, cable cars or roller coasters where the travelling routine is more fixed. In an embodiment, the entire video which is captured during the trip may be compared with the standard video, so as to make a more accurate conclusion of road quality inspection. In addition, the proposed solution also may be used to inspect road facilities simultaneously based on the captured video, thereby detecting some abnormal situations of the road facilities, e.g., a road sign is damaged, a traffic light is malfunctioned, etc.

Many advantageous may be achieved by implementing exemplary embodiments. For example, the road inspection cost in both manhours and devices may be reduced, and the potential traffic congestions may be mitigated. Since various existing devices and vehicles travelling along the road can be utilized in the proposed solution, there may be no need to arm with many professional road inspection devices, and there may be no need to allocate manhours to inspect the road quality frequently either. When any suspected and/or potential road damages discovered, vehicles may be informed as required, so that they may speed down to avoid accidents or detour. In this way, the safety can be more guaranteed. Furthermore, traffic facility status may be observed from the video analysis, and the maintenance team may be informed to repair the facilities when needed. Overall, various exemplary embodiments of the present disclosure can make the road itself also more intelligence by utilizing different UEs or terminal devices, e.g., vehicles, trains, cable cars and etc. In this way, the efficiency of road inspection may be higher, and the cost may become lower.

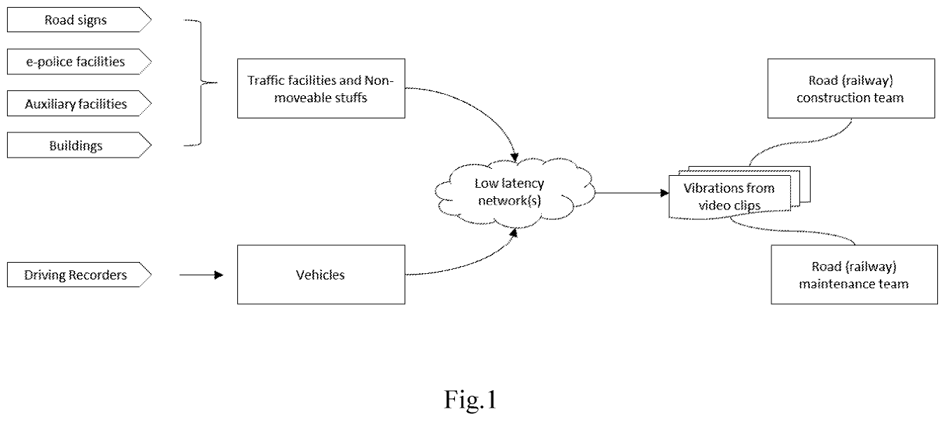

FIG. 1 is a diagram illustrating an exemplary system architecture according to an embodiment of the present disclosure. In the system architecture, many existing traffic facilities and non-moveable stuffs may be utilized, e.g., road signs, e-police facilities, auxiliary facilities, buildings, etc., and can be enhanced by one or more communication networks, e.g. low latency network(s) such as 5G/NR, etc. that may be able to communicate with vehicles. Driving recorders of the vehicles may be used to capture video clips of roads. The communication network may transfer the captured video clips from the vehicles to a road construction team and/or a maintenance team. In an embodiment, vibrations from the video clips may be suspected to be an indicator of a damaged road section.

In accordance with an exemplary embodiment, the system architecture may be implemented in both hardware and software areas, and in practice, the joint effort from vehicles, traffic facilities as well as the road maintenance team can make it into reality.

For hardware implementations, many existing devices, such as traffic lights, road signs, isolation zones, height limitation bars, etc. are fixed assets. These traffic facilities are naturally unmovable things that may be set as “baseline” for measurement when performing road quality inspection. In an embodiment, the facilities may be used as baseline without installing any extra equipment. In this case, the road inspection may be implemented purely by analyzing the video captured to determine whether there is any abnormal situation found. In another embodiment, the road inspection may be enhanced with infrared imaging, e.g., by comparing the vehicle factory's standard engine working condition curve. If the road inspection system discovers the engine which is in fatigue, then the system can prompt the driver to have a rest.

In accordance with an exemplary embodiment, a driving recorder of a vehicle may be utilized for road inspection. If video clips from the video streams captured by the driving recorder for a road section has more and more offsets while comparing with the initial (standard) video clip (e.g., in a same category/type of vehicles), most probably the road section may have some potential quality issues that expect to be inspected by human, e.g., there may be some uneven road surfaces and they are tend to be deteriorated. The embodiments for road inspection also may be applied to railway systems.

In accordance with an exemplary embodiment, a radar device can be installed on a vehicle. When the vehicle is approaching or leaving a traffic facility(s), a video clip corresponding to the specified period may be got from video streams for analysis, thereby enhancing the accuracy of road inspection. According to an embodiment, the vehicle in a good repair condition may be utilized to assist the road inspection. If the vehicle is not in a good repair condition, the captured video stream may also have some pattern of vibrations already. In order to (re-)calibrate this, the road inspection system may be adjusted automatically or as required.

In accordance with an exemplary embodiment, when a road construction is completed, there may be a UE (e.g., a vehicle such as a car, a train, etc., or an in-vehicle device such as a driving recorder or a camera, etc.) travelling along it at a certain velocity with a pre-defined routine to capture a video as smoothness baseline. Due to the natural of civil engineering, there may be tiny vibrations reflected in the video as offsets that are limited within the quality specification. According to an embodiment, for the vehicles of some common models that take up a certain percentage of the market share rank list, the initial road smoothness baseline function finis (t) may be defined as below:

ƒᵢₙᵢₜ(t)∈{ƒ₁(t),ƒ₂(t), . . . ,ƒ_{N}(t)} (1)
where ƒ₁(t), ƒ₂(t), . . . , ƒ_{N}(t) represent the initial road smoothness baseline function for Model 1, Model 2, . . . , Model N, respectively. In an embodiment, the initial road smoothness baseline function ƒᵢₙᵢₜ(t) can be obtained by the road construction team while building up the road or estimated by mathematical modeling. As time t goes by, the smoothness of the road may be changed, and thus the real road smoothness function Fᵣₑₐₗ(t) may have some offset delta Δ relative to ƒᵢₙᵢₜ(t), which may be expressed as below:

Fᵣₑₐₗ(t)∈{F₁(t),F₂(t), . . . ,F_{N}(t)} (2)

Δ=Fᵣₑₐₗ(t)−ƒᵢₙᵢₜ(t) (3)
where F₁(t), F₂(t), . . . , F_{N}(t) represent the real road smoothness function for Model 1, Model 2, . . . , Model N, respectively. In an embodiment, the real road smoothness function Fᵣₑₐₗ(t) can be obtained from the real road measurement of the specified vehicles. For a certain model/type of a vehicle, e.g., Model n, if the corresponding offset delta Δₙ is big enough, e.g., equal to or larger than a threshold for this model/type of the vehicle, the measured road section may need to be inspected and/or repaired by the road maintenance team.

In accordance with an exemplary embodiment, it may be possible to establish a road damage model by collecting vibration patterns in some certain already damaged road sections. When there is a feedback from vehicles in the real usage matched with one or more patterns according to the road damage model, the road maintenance team may easily assume the severity level of the damage so as to prioritize their works.

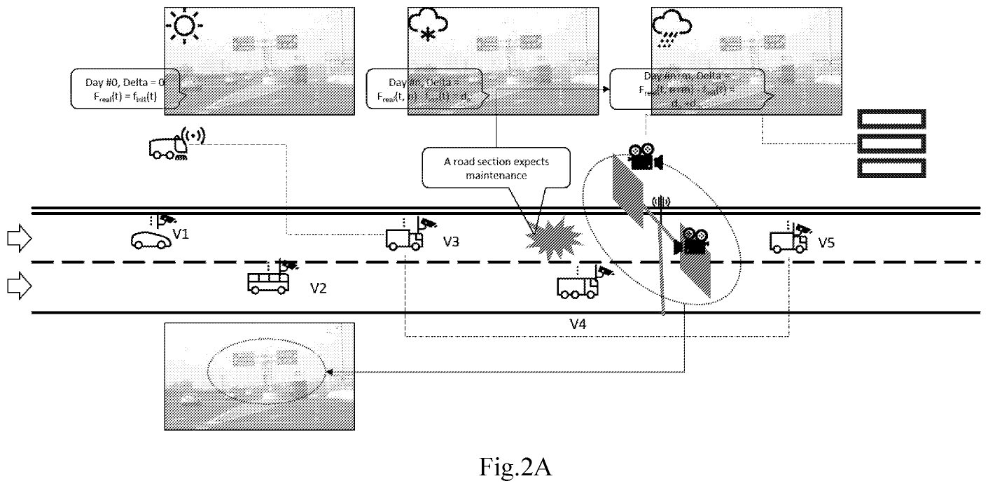

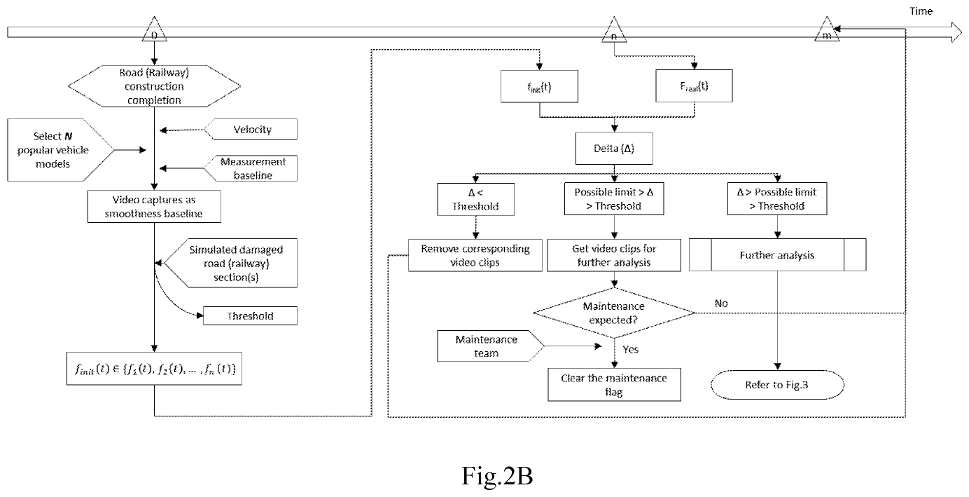

FIG. 2A is a diagram illustrating an exemplary system design according to an embodiment of the present disclosure. As shown in FIG. 2A, there is an existing road indicator sign established in the branching point of roads. Two cameras may be installed on the road indicator sign and accessed by low latency network(s). The first camera is towards the vehicle travelling direction and the other one is in the same direction of that. A driving recorder or any type of camera installed at a vehicle (e.g., V1, V2, V3, V4 and V5 in FIG. 2A) may be responsible for capturing a video stream or video clips. The captured video may be uploaded to a server for analysis as required. For example, when the vehicle travels along the road and enters a certain road section, the captured video may be transmitted from the vehicle to the server.

In accordance with an exemplary embodiment, the captured video and the reference video for the road section may be represented by Fᵣₑₐₗ(t) and ƒᵢₙᵢₜ(t), respectively. For Day #0, since Fᵣₑₐₗ(t)=ƒᵢₙᵢₜ(t), i.e., the captured video and the reference video are obtained on the same day, the offset delta of the captured video relative to the reference video is equal to 0. For Day #n, as shown in FIG. 2A, the offset delta of the captured video relative to the reference video is Fᵣₑₐₗ(t, n)−ƒᵢₙᵢₜ(t)=dₙ. Similarly, for Day #n+m, the offset delta of the captured video relative to the reference video is Fᵣₑₐₗ(t, n+m)−ƒᵢₙᵢₜ(t)=dₙ+dₘ. If the server detects the offset delta equal to or larger than a threshold, the server may instruct a road maintenance team to maintain/repair the road section. For example, the road section may expect maintenance in the case that the captured video on Day #n+m has the offset delta larger than the maintenance threshold, as shown in FIG. 2A.

According to different implementations, the server for road inspection may be deployed on the cloud side (such as the network), or the edge computing side (such as a sub-district of a city area), or a base station, or a traffic facility, or a vehicle side (e.g., the vehicle may analyze the captured video locally and when it discovers abnormal vibrations, the vehicle may report the abnormal vibrations to the server). Various implementations may be adopted in practice, e.g., based on cloud services, in a distributed or centralized manner, etc., and the deployment may be realized according to the traffic and road status.

In accordance with an exemplary embodiment, the server for road inspection may be able to detect not only road damage but also a potential problem of a vehicle that may expect repair. For example, an infra camera may be installed on a traffic facility such as a road indicator sign to discover any overheat engines (of vehicles). If the server discovers any abnormal status of a vehicle, it may inform the vehicle's driver of the abnormal status.

FIG. 2B is a diagram illustrating an exemplary road inspection procedure according to an embodiment of the present disclosure. As shown in FIG. 2B, when a road (railway) section construction is completed and open to the people, during the first couple of days, a server for road inspection may firstly select some popular vehicle models (e.g., N popular vehicle models) with a moderate velocity under the measurement baseline (standard), and record the video clips for these vehicle models as smoothness baseline of this road (railway) section. In an embodiment, the server may obtain some video clips for road (railway) sections in different damaged levels, e.g., by simulation or getting from an existing model, and then determine a threshold of each road (railway) section by comparing these video clips and the smoothness baseline. When the time goes by, the server can calculate the offset delta Δ of the real road video clips Fᵣₑₐₗ(t) relative to the smoothness baseline ƒᵢₙᵢₜ(t). By comparing the delta Δ and a threshold, the server can determine whether maintenance is expected for the road section and/or whether a further analysis may be needed. For example, if Δ<Threshold, the server can determine that the maintenance is not expected and may remove the corresponding video clips. If Δ>Threshold, the server may get the video clips for further analysis to determine whether the maintenance is expected for the corresponding road section. In an embodiment, a parameter “Possible limit” may be introduced to represent the maximum damage to the road in general. If Possible limit>Δ>Threshold, meaning that the potential road damage reflected by the offset delta is reasonable, then the server may make a further analysis to determine whether the maintenance is expected for the corresponding road section. If the analysis result indicates that the maintenance is expected, the server may inform the road maintenance team. When the road section is maintained or repaired, the server may clear the maintenance flag for the road section. If Δ>Possible limit>Threshold, implying that the potential road damage reflected by the offset delta is abnormal, then the server may need to perform a further analysis on the video clips to determine how to handle this abnormal situation, e.g., whether to adjust the road inspection by (re-)calibrating road inspection means, whether to discard the video clips and ignore the road inspection result, etc.

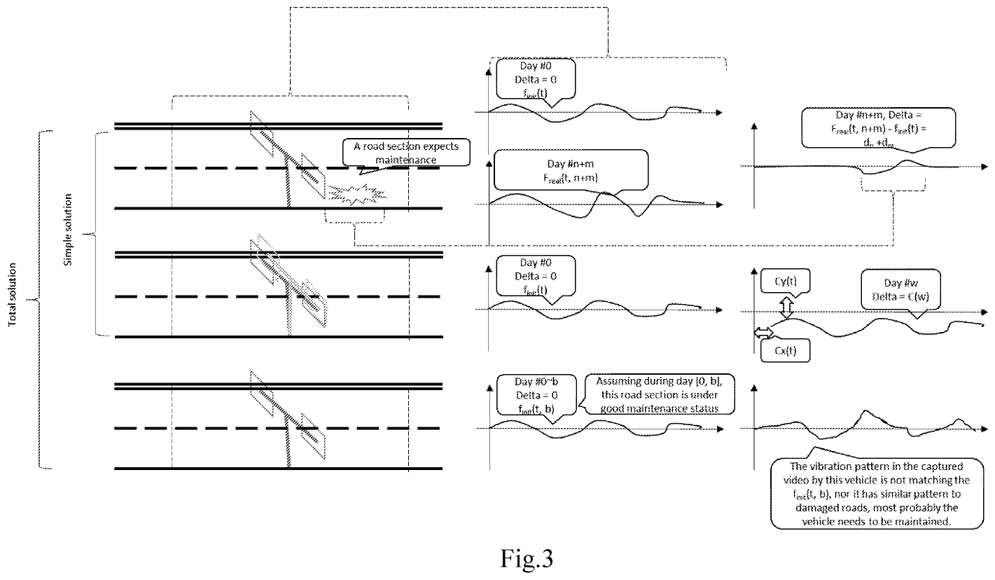

FIG. 3 is a diagram illustrating an exemplary solution of video analysis according to an embodiment of the present disclosure. The server for road inspection may use this solution to discover any road (railway) damage and/or any vehicle expected maintenance. In an embodiment, after n+m days, there may be a delta of dₙ+dₘ as the result of Fᵣₑₐₗ(t, n+m)−ƒᵢₙᵢₜ(t). If the delta is bigger than the threshold, this road (railway) section may expect maintenance. In another embodiment, when there is a significant offset on X axis and/or Y axis (e.g., Cₓ(t) and C_{y}(t) shown in FIG. 3) after “w” days, most probably the facility where the camera installed has movement. In this case, the server can automatically (re-)calibrate the X/Y axis and/or request repair. In another embodiment, assuming during 0−b days, this road section is under good maintenance status, but the vibration pattern in the captured video by a vehicle is not matching the baseline function ƒᵢₙᵢₜ(t, b), nor it has similar pattern to damaged roads. In this case, it may be possible that the vehicle needs to be maintained. In addition, in the case that the bi-direction communication between the vehicle and the server via a low latency network is supported, the server may discover some abnormal pattern of vibrations from the vehicle, and can inform the driver to check the abnormal situation of the vehicle.

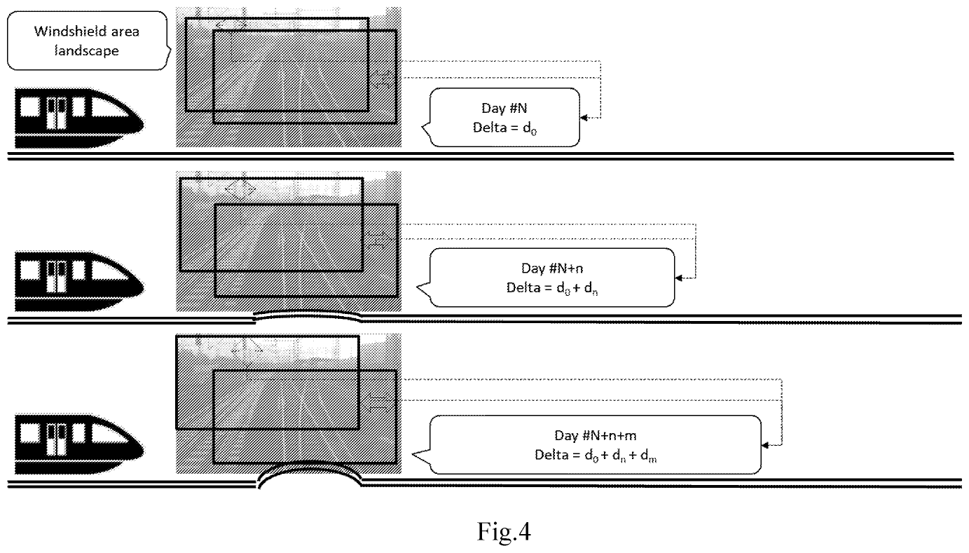

FIG. 4 is a diagram illustrating an exemplary rail deform inspection assistant solution according to an embodiment of the present disclosure. In the solution illustrated in FIG. 4, a travelling train may collect image/video data of a rail, and a server (e.g., a processor installed or implemented at the train) can calculate a delta of the collected image/video data relative to the reference data. Based on the calculated delta, the server can determine whether the rail deform is distinct enough for maintenance. Similar to the solutions as described with respect to FIG. 2A, FIG. 2B and FIG. 3, if the delta meets the threshold someday, e.g., Day #N+n+m, then the server may inform a maintenance team to inspect the form of the rail to ensure the smoothness.

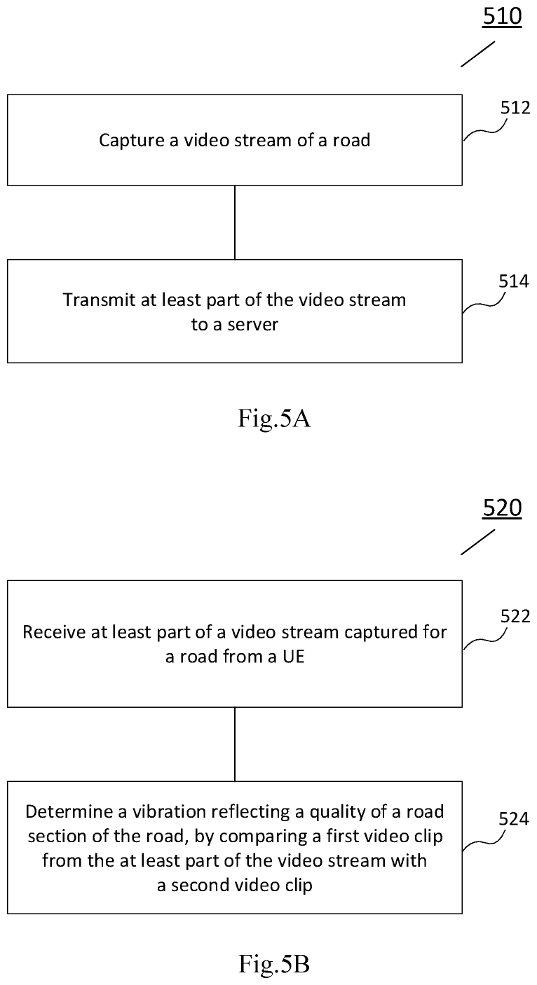

FIG. 5A is a flowchart illustrating a method 510 according to some embodiments of the present disclosure. The method 510 illustrated in FIG. 5A may be performed by a UE or an apparatus communicatively coupled to the UE. In accordance with an exemplary embodiment, the UE may be provided with one or more services, e.g., via a communication network such as 5G/NR network. In addition, the UE may be configured to support or assist road inspection according to various embodiments.

According to the exemplary method 510 illustrated in FIG. 5A, the UE may capture a video stream of a road, as shown in block 512, and transmit at least part of the video stream to a server, as shown in block 514. In accordance with an exemplary embodiment, a first video clip from the at least part of the video stream may be compared with a second video clip to determine a vibration reflecting a quality of a road section of the road. It can be appreciated that the comparison between the first video clip and the second video clip may be performed by the UE or the server.

In accordance with an exemplary embodiment, the second video clip may be a reference video clip used as a quality baseline of the road section. According to an exemplary embodiment, the second video clip may correspond to the road section with a quality equal to or higher than a predefined level.

In accordance with an exemplary embodiment, the UE may be a vehicle (e.g., a car, a train, or any suitable transport means) or a device (e.g., a driving recorder, a camera, or any suitable in-vehicle means) used for the vehicle. In an embodiment, the second video clip may be associated with a type/model of the vehicle.

In accordance with an exemplary embodiment, the vibration reflecting the quality of the road section may include one or more offsets of the first video clip relative to the second video clip. According to an exemplary embodiment, when the vibration matches a vibration pattern, the vibration may indicate one or more of:
a potential damage of the road section;
a level of the potential damage;
a road facility set on or around the road section being malfunctioned and/or moved;
a need for adjusting (e.g., (re-)calibrating road inspection means or algorithm(s) used for) quality inspection of the road section; and
an abnormal status of the UE.

In accordance with an exemplary embodiment, the vibration pattern may include one or more video offsets within a predefined range, e.g., a first range which may include one or more sub-ranges corresponding to different damage levels, or a second range associating with the need for adjusting quality inspection of the road section, etc.

In accordance with an exemplary embodiment, the first video clip may be determined by the UE and/or the server. According to an exemplary embodiment, the first video clip may be determined according to one or more of:
the UE being distant from a road facility by a predefined value;
the UE arriving at a predetermined position; and
the UE entering and/or leaving the road section.

In accordance with an exemplary embodiment, the comparison between the first video clip and the second video clip may be based at least in part on one or more of:
a relative position of the UE to a road facility;
an absolute position of the UE; and
a trajectory of the UE.

In accordance with an exemplary embodiment, the UE may receive a notification from the server. The notification may indicate a potential damage of the road section and/or an abnormal status of the UE. According to an exemplary embodiment, the abnormal status of the UE may be determined (e.g., by the server or any other suitable devices which can detect the abnormal status of the UE) according to the vibration reflecting the quality of the road section and/or sensor data collected by one or more road facilities for the UE.

FIG. 5B is a flowchart illustrating a method 520 according to some embodiments of the present disclosure. The method 520 illustrated in FIG. 5B may be performed by a server or an apparatus communicatively coupled to the server. In accordance with an exemplary embodiment, the server may be configured to provide one or more services to a UE, e.g., via a communication network such as 5G/NR network. In addition, the server may be configured to support or assist road inspection according to various embodiments. In accordance with an exemplary embodiment, the server may be implemented at the UE, a base station, a road facility, an edge computing device, and/or a cloud device.

According to the exemplary method 520 illustrated in FIG. 5B, the server may receive at least part of a video stream captured for a road from a UE, as shown in block 522. In accordance with an exemplary embodiment, the server may determine a vibration reflecting a quality of a road section of the road, by comparing a first video clip from the at least part of the video stream with a second video clip, as shown in block 524.

In accordance with some exemplary embodiments, the at least part of the video stream received by the server according to the method 520 may correspond to the at least part of the video stream transmitted by the UE according to the method 510. Similarly, the first video clip and the second video clip as described with respect to FIG. 5B may respectively correspond to the first video clip and the second video clip as described with respect to FIG. 5A. Thus, the first/second video clip as described with respect to FIG. 5A and the first/second video clip as described with respect to FIG. 5B may have the same or similar contents and/or feature elements. Correspondingly, the determination of the vibration reflecting the quality of the road section according to the method 510 and the method 520 may be based on the same or similar parameter(s) and/or criterion(s).

In accordance with an exemplary embodiment, when the vibration indicates a potential damage of the road section, the server may inform the potential damage of the road section to the UE, one or more other UEs, a road construction team, and/or a road maintenance team. In accordance with another exemplary embodiment, the server may transmit a notification to the UE to indicate an abnormal status of the UE.

In accordance with an exemplary embodiment, the server may obtain sensor data collected by one or more road facilities for the UE. Based at least in part on the sensor data, the server may perform the comparison between the first video clip and the second video clip. According to a result of the comparison, the server can determine whether there is a road damage, a malfunctioned facility, and/or an abnormal status of the UE, etc.

In accordance with an exemplary embodiment, the server for road inspection as described with respect to various embodiments can be implemented by utilizing artificial intelligence (AI). In this case, the server may have the ability of a computer implemented or computer-controlled device to perform tasks commonly associated with intelligent beings. In an embodiment, the server may utilize machine learning to perform a specific task, e.g., establishing a road damage model, obtaining video vibration patterns corresponding to damage levels, determining offset delta thresholds, etc. Machine learning solutions can use results from data analytics and/or data mining to “interact” with the physical world in a way which may be regarded as “intelligent”. In addition, the server capable of machine learning can facilitate the road inspection by analysis of video data, making assumptions, learning and providing predictions or reasoning at a scale and depth of detail impossible for individual human analysts.

The various blocks shown in FIGS. 5A-5B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

Various embodiments according to the present disclosure can improve the road quality inspection efficiency and reduce the maintenance cost by utilizing the civil vehicles (trains) that may be always travelling along a road. Existing solutions may rely on the professional equipment and work team, which may be inefficient due to limited road maintenance budget and/or human resources. Moreover, in an embodiment, popular vehicle models may be automatically picked up based on the figures in vehicle management bureau yearly to ensure that sufficient data (e.g., video clips) may be used to guarantee the inspection quality. According to exemplary embodiments, image analysis and vibration analysis (e.g., on video streams or video clips from driving recorders, etc.) may be combined appropriately, which can improve the accuracy of road inspection. The server for road inspection according to various embodiments may be self-adopted to different scenarios and automatically report issues when detecting any suspected damage and malicious destruction of roads and traffic facilities. In addition, the road materials percentage and craftsmanship model analysis may also be established, e.g., as variants of time, weight, etc. factors related to vehicles (trains). This may let the road undergo real world experiences and collect feedbacks, and then the supplier can use these data for improvement in an appropriate time.

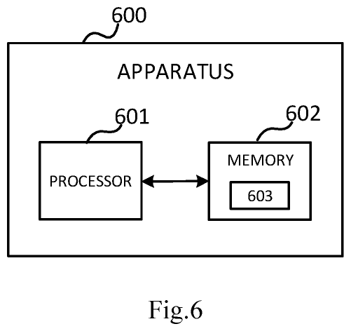

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a UE as described with respect to FIG. 5A, or a server as described with respect to FIG. 5B. In such cases, the apparatus 600 may be implemented as a UE as described with respect to FIG. 5A, or a server as described with respect to FIG. 5B.

In some implementations, the one or more memories 602 and the computer program codes 603 may be configured to, with the one or more processors 601, cause the apparatus 600 at least to perform any operation of the method as described in connection with FIG. 5A. In other implementations, the one or more memories 602 and the computer program codes 603 may be configured to, with the one or more processors 601, cause the apparatus 600 at least to perform any operation of the method as described in connection with FIG. 5B. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

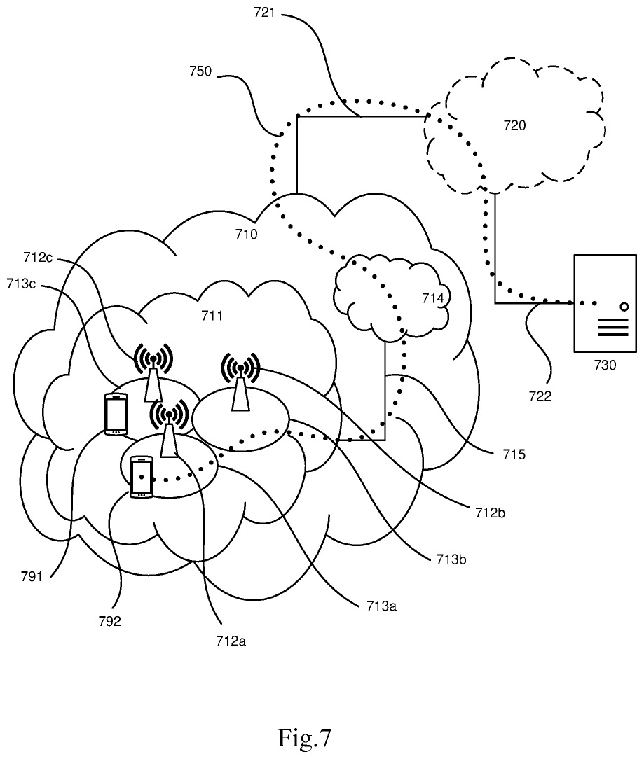

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

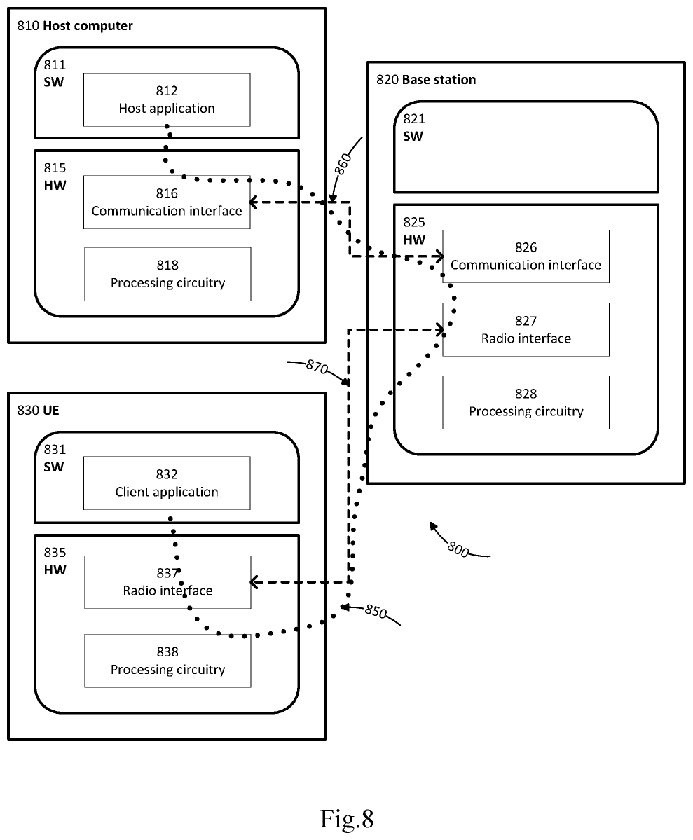

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

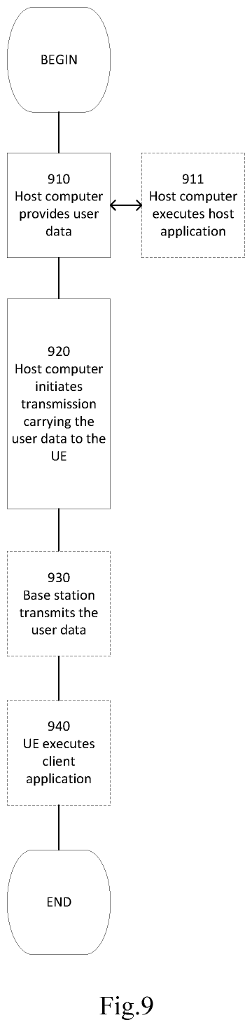

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

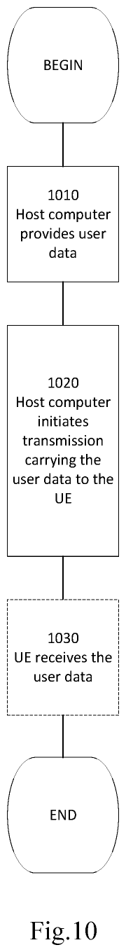

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

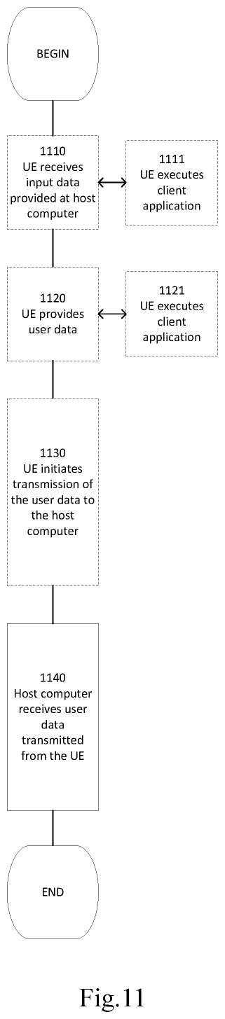

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

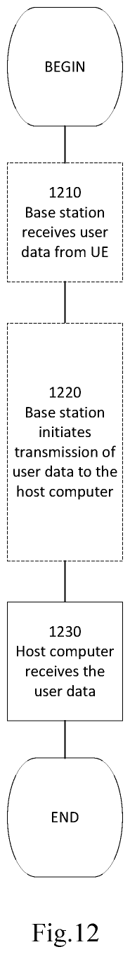

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 520 as describe with respect to FIG. 5B.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 520 as describe with respect to FIG. 5B.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 510 as describe with respect to FIG. 5A.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 510 as describe with respect to FIG. 5A.

According to some exemplary embodiments, there is provided a method implemented in a communication system which may include a host computer, a base station and a UE. The method may comprise, at the host computer, receiving user data transmitted to the base station from the UE which may perform any step of the exemplary method 510 as describe with respect to FIG. 5A.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 510 as describe with respect to FIG. 5A.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 520 as describe with respect to FIG. 5B.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 520 as describe with respect to FIG. 5B.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a user equipment, comprising:
capturing a video stream of a road; and
transmitting at least part of the video stream to a server, wherein a first video clip from the at least part of the video stream is compared with a second video clip to determine a vibration reflecting a quality of a road section of the road.

2. The method according to claim 1, wherein the second video clip is a reference video clip used as a quality baseline of the road section.

3. The method according to claim 1, wherein the second video clip corresponds to the road section with a quality equal to or higher than a predefined level.

4. The method according to claim 1, wherein the user equipment is a vehicle or a device used for the vehicle, and the second video clip is associated with a type of the vehicle.

5. The method according to claim 1, wherein the vibration includes one or more offsets of the first video clip relative to the second video clip.

6. The method according to claim 1, wherein when the vibration matches a vibration pattern, the vibration indicates one or more of:
a potential damage of the road section;
a level of the potential damage;
a road facility set on or around the road section being malfunctioned and/or moved;
a need for adjusting quality inspection of the road section; and
an abnormal status of the user equipment.

7. The method according to claim 6, wherein the vibration pattern includes one or more video offsets within a predefined range.

8. The method according to claim 1, wherein the first video clip is determined by the user equipment and/or the server.

9. The method according to claim 8, wherein the first video clip is determined according to one or more of:
the user equipment being distant from a road facility by a predefined value;
the user equipment arriving at a predetermined position; and
the user equipment entering and/or leaving the road section.

10. The method according to claim 1, wherein the comparison between the first video clip and the second video clip is based at least in part on one or more of:
a relative position of the user equipment to a road facility;
an absolute position of the user equipment; and
a trajectory of the user equipment.

11. The method according to claim 1, further comprising:
receiving a notification from the server, wherein the notification indicates a potential damage of the road section and/or an abnormal status of the user equipment.

12. The method according to claim 11, wherein the abnormal status of the user equipment is determined by the server according to one or more of:
the vibration reflecting the quality of the road section; and
sensor data collected by one or more road facilities for the user equipment.

13. The method according to claim 1, wherein the server is implemented at one or more of: the user equipment, a base station, a road facility, an edge computing device, and a cloud device.

14. A user equipment, comprising:
one or more processors; and
one or more memories comprising computer program codes,
the one or more memories and the computer program codes configured to, with the one or more processors, cause the user equipment at least to:
capture a video stream of a road; and
transmit at least part of the video stream to a server, wherein a first video clip from the at least part of the video stream is compared with a second video clip to determine a vibration reflecting a quality of a road section of the road.

15. The user equipment according to claim 14, wherein the one or more memories and the computer program codes are configured to, with the one or more processors, cause the user equipment to perform further operations comprising:
receive a notification from the server, wherein the notification indicates a potential damage of the road section and/or an abnormal status of the user equipment.

16. (canceled)

17. A method performed by a server, comprising:
receiving at least part of a video stream captured for a road from a user equipment; and
determining a vibration reflecting a quality of a road section of the road, by comparing a first video clip from the at least part of the video stream with a second video clip.

18. The method according to claim 17, wherein the second video clip is a reference video clip used as a quality baseline of the road section.

19. The method according to claim 17, wherein the second video clip corresponds to the road section with a quality equal to or higher than a predefined level.

20. The method according to claim 17, wherein the user equipment is a vehicle or a device used for a vehicle, and the second video clip is associated with a type of the vehicle.

21. The method according to claim 17, wherein the vibration includes one or more offsets of the first video clip relative to the second video clip.

22.-34. (canceled)
